(19) United States
(12) Patent Application Publication
(10) Pub. No.: US 2015/0278369 A1
(43) Pub. Date: Oct. 1, 2015

(54) Method And Apparatus For Aggregating Healthcare Information

(71) Applicant: MCKESSON FINANCIAL HOLDINGS, Hamilton (BM)

(72) Inventors: Eldon Allan Wong, Vancouver (CA); Marianne Lee, Vancouver (CA)

(73) Assignee: MCKESSON FINANCIAL HOLDINGS, Hamilton (BM)

(21) Appl. No.: 14/229,175

(22) Filed: Mar. 28, 2014

(51) Int. Cl. G06F 17/30; G06F 19/00

(52) U.S. Cl. CPC G06F 17/30867; G06F 19/322

(57) ABSTRACT

A method, apparatus and computer program product are provided in order to provide a context-aware clinical portal. An example method may include receiving an environment context. The environment context may include information relating to at least one of a user task, a user action, or an open application. The method may also include determining, based on the environment context, at least one portlet for providing clinical information related to the environment context. The at least one portlet may provide an interface control for at least one of viewing or accessing the clinical information. The method may also include generating a context-aware clinical portal comprising the at least one portlet, and providing the context-aware clinical portal.

### TECHNOLOGICAL FIELD

Example embodiments of the present invention relate generally to accessing healthcare data and, more particularly, to providing a context-aware healthcare information portal.

### BACKGROUND

As medical science increasingly relies on access to electronic records, practitioners find themselves accessing more electronic data from different sources during their day-to-day tasks. During a typical day, a practitioner may access patient electronic medical records, view imaging studies, chart patient cases, review correspondence from other practitioners, and interact with hospital calendar and personnel management systems. Furthermore, in order to stay current with the changes and discoveries in health care science, practitioners may access resources such as web searches, physician websites, electronic catalogs, teaching file items, consulting resources/information created/posted by colleagues that specialize in certain areas, and the like. These resources may aid with treating their patients and provide the practitioner better context and understanding in their jobs.

However, accessing all of these information sources may require the use of multiple applications or devices. Even if the practitioner has access to each of these resources via a web interface, the practitioner must still manually select which resources to view. In some cases, the practitioner may be unaware of a change or update to a particularly important resource, and if the practitioner does not check the resource regularly, they may miss the update. Known systems lack any awareness of the practitioner's environment context, requiring the practitioner to manually, and often, inefficiently, make judgment calls about which resource to access and when to access it. Through applied effort, ingenuity, and innovation, Applicant has solved many of these identified problems by developing a solution that is embodied by the present invention, which is described in detail below

### BRIEF SUMMARY

A method, apparatus and computer program product are therefore provided according to an example embodiment of the present invention in order to provide a context-aware information portal. Embodiments may include a method. The method includes receiving an environment context. The environment context includes information relating to at least one of a user task, a user action, or an open application. The method also includes determining, using a processor and based on the environment context, at least one portlet for providing clinical information related to the environment context. The at least one portlet provides an interface control for at least one of viewing or accessing the clinical information. The method further includes generating a context-aware clinical portal comprising the at least one portlet, and providing the context-aware clinical portal. The environment context may include information provided by at least one of a picture archiving and communication system, a calendar application, an electronic health records system, or a medical reference application. The method may also include receiving at least one update to the environment context, and updating the context-aware clinical portal based on the updated environment context. The update to the environment context may be received from the at least one portlet. The update received from the at least one portlet may extend the environment context by adding at least one additional attribute to the environment context not present prior to the update. The clinical information may include at least one of a link to a medical reference resource, a link to a patient electronic health record, or a link to a medical imaging study. The method may also include associating a sequence priority to each of the at least one portlets, and determining the clinical information for each of the at least one portlets according to the sequence priority. The environment context may be provided at least in part by an application programming interface. The environment context may include at least one of a patient identifier, a patient symptom, an open examination attribute, an open procedure attribute, patient demographic information, or a user clinical specialty. The context-aware clinical portal may be provided via a web page interface.

Additional embodiments may include an apparatus for providing a context-aware clinical portal. The apparatus includes processing circuitry. The processing circuitry is configured to cause the apparatus to receive an environment context. The environment context includes information relating to at least one of a user task, a user action, or an open application. The processing circuitry may be further configured to cause the apparatus to determine, based on the environment context, at least one portlet for providing clinical information related to the environment context. The at least one portlet provides an interface control for at least one of viewing or accessing the clinical information. The processing circuitry is further configured to cause an apparatus to generate a context-aware clinical portal comprising the at least one portlet, and to provide the context-aware clinical portal. The environment context may include information provided by at least one of a picture archiving and communication system, a calendar application, an electronic health records system, or a medical reference application. The processing circuitry may be further configured to cause the apparatus to receive at least one update to the environment context, and to update the context-aware clinical portal based on the updated environment context. The update to the environment context may be received from the at least one portlet. The update received from the at least one portlet may extend the environment context by adding at least one additional attribute to the environment context not present prior to the update. The clinical information may include at least one of a link to a medical reference resource, a link to a patient electronic health record, or a link to a medical imaging study. The processing circuitry may be further configured to cause the apparatus to associate a sequence priority to each of the at least one portlets, and to determine the clinical information for each of the at least one portlets according to the sequence priority. The environment context may be provided at least in part by an application programming interface. The environment context may include at least one of a patient identifier, a patient symptom, an open examination attribute, an open procedure attribute, patient demographic information, or a user clinical specialty.

Embodiments may further provide a computer program product for providing a context-aware clinical portal. The computer program product includes at least one computer-readable storage medium bearing computer program instructions embodied therein for use with a computer. The computer program instructions include program instructions configured to receive an environment context. The environment context includes information relating to at least one of a user task, a user action, or an open application. The computer program instructions further include instructions configured to determine, based on the environment context, at least one portlet for providing clinical information related to the environment context, wherein the at least one portlet provides an interface control for at least one of viewing or accessing the clinical information. The computer program instructions also include instructions configured to generate a context-aware clinical portal comprising the at least one portlet, and to provide the context-aware clinical portal.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus that may be specifically configured in accordance with example embodiments of the present invention;

FIG. 2 is a block diagram of a data flow in a context-aware clinical portal in accordance with example embodiments of the present invention;

FIG. 3 is an illustration of an interface for providing a context-aware clinical portal in accordance with example embodiments of the present invention;

FIG. 4 is a flow diagram of an example method for providing a context-aware clinical portal in accordance with example embodiments of the present invention; and

FIG. 5 is a flow diagram of an example method for determining an environment context using a portlet extended context in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout

### INTRODUCTION AND DEFINITIONS

A method, apparatus and computer program product are provided in accordance with an example embodiment of the present invention in order to provide a context-aware clinical portal. In this regard, a method, apparatus and computer program product of an example embodiment may determine an environment context. The environment context may be utilized to generate a portal that provides a variety of clinical information relevant to the environment context. Generation of the portal may include selection of one or more portlets, and selecting content for the portlets. The term “portlet” is generally understood to refer to a user interface software component that is designed for display portal interface. In some embodiments, portlets may add to the environment context such that the content of one portlet may be used in selection of content for another portlet.

For the purpose of this application, the term “environment context” means information received from one or more applications or modules that relate to a user's tasks, responsibilities, or actions. For example, an environment context may be derived from information provided by a plurality of applications, including but not limited to medical imaging viewing applications, electronic patient health record applications, calendar applications, personnel management applications, social networking applications, really simple syndication (RSS) feeds, academic journal subscription applications, or the like.

### Example Apparatus

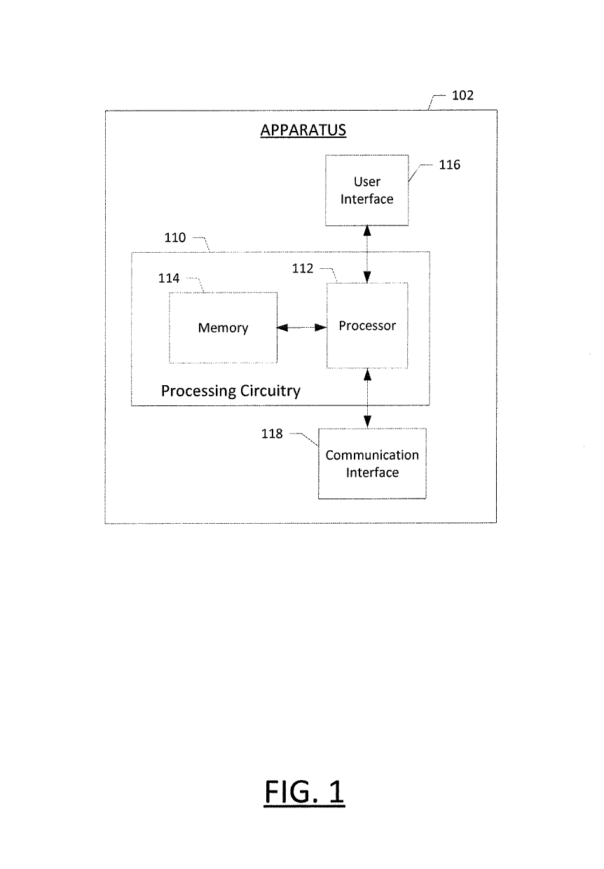

FIG. 1 illustrates a block diagram of an apparatus 102 in accordance with some example embodiments. The apparatus 102 may be any computing device capable of providing a context-aware clinical portal as described herein. For example, the apparatus 102 may be implemented as a server (e.g., an application server implemented as a standalone or rack-mounted server), a smart phone, a personal digital assistant, a tablet computer, a netbook computer, a laptop, a picture archiving and communication system (PACS) workstation, or a desktop computer. The apparatus 102 may be operable to determine and/or receive an environment context, and/or to generate the context-aware clinical portal by selecting and configuring portlets based on the environment context. Accordingly, it will be appreciated that the apparatus 102 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

The apparatus 102 may include or otherwise be in communication with processing circuitry 110 that is configurable to perform actions in accordance with one or more example embodiments disclosed herein. In this regard, the processing circuitry 110 may be configured to perform and/or control performance of one or more functionalities of the apparatus 102 (e.g., functionalities of a computing device on which the apparatus 102 may be implemented) in accordance with various example embodiments, and thus may provide means for performing functionalities of the apparatus 102 (e.g., functionalities of a computing device on which the apparatus 102 may be implemented) in accordance with various example embodiments. The processing circuitry 110 may be configured to perform data processing, application execution and/or other processing and management services according to one or more example embodiments. In some embodiments, the apparatus 102 or a portion(s) or component(s) thereof, such as the processing circuitry 110, may be embodied as or comprise a chip or chip set. In other words, the apparatus 102 or the processing circuitry 110 may comprise one or more physical packages (e.g., chips) including materials, components and/or wires on a structural assembly (e.g., a baseboard). The apparatus 102 or the processing circuitry 110 may therefore, in some cases, be configured to implement an embodiment of the invention on a single chip or as a single “system on a chip.” As such, in some cases, a chip or chipset may constitute means for performing one or more operations for providing the functionalities described herein.

In some example embodiments, the processing circuitry 110 may include a processor 112 and, in some embodiments, such as that illustrated in FIG. 1, may further include memory 114. The processing circuitry 110 may be in communication with or otherwise control a user interface 116 and/or a communication interface 118. As such, the processing circuitry 110 may be embodied as a circuit chip (e.g., an integrated circuit chip) configured (e.g., with hardware, software or a combination of hardware and software) to perform operations described herein.

The processor 112 may be embodied in a number of different ways. For example, the processor 112 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 112 may comprise a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In some example embodiments, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry—in the form of processing circuitry 110) capable of performing operations according to embodiments of the present invention while configured accordingly. Thus, for example, when the processor 112 is embodied as an ASIC, FPGA or the like, the processor 112 may be specifically configured hardware for conducting the operations described herein. Alternatively, as another example, when the processor 112 is embodied as an executor of software instructions, the instructions may specifically configure the processor 112 to perform one or more operations described herein.

In some example embodiments, the memory 114 may include one or more non-transitory memory devices such as, for example, volatile and/or non-volatile memory that may be either fixed or removable. In this regard, the memory 114 may comprise a non-transitory computer-readable storage medium. It will be appreciated that while the memory 114 is illustrated as a single memory, the memory 114 may comprise a plurality of memories. The plurality of memories may be embodied on a single computing device or may be distributed across a plurality of computing devices collectively configured to function as the apparatus 102. The memory 114 may be configured to store information, data, applications, instructions and/or the like for enabling the apparatus 102 to carry out various functions in accordance with one or more example embodiments. For example, the memory 114 may be configured to buffer input data for processing by the processor 112. Additionally or alternatively, the memory 114 may be configured to store instructions for execution by the processor 112. As yet another alternative, the memory 114 may include one or more databases that may store a variety of files, contents or data sets. Among the contents of the memory 114, applications may be stored for execution by the processor 112 in order to carry out the functionality associated with each respective application. In some cases, the memory 114 may be in communication with one or more of the processor 112, user interface 116, or communication interface 118 via a bus or buses for passing information among components of the apparatus 102.

The user interface 116 may be in communication with the processing circuitry 110 to receive an indication of a user input at the user interface 116 and/or to provide an audible, visual, mechanical or other output to the user. As such, the user interface 116 may include, for example, a keyboard, a mouse, a joystick, a display, a touch screen display, a microphone, a speaker, a Light Emitting Diode (LED), a lighting device, and/or other input/output mechanisms.

The communication interface 118 may include one or more interface mechanisms for enabling communication with other devices and/or networks. In some cases, the communication interface 118 may be any means such as a device or circuitry embodied in either hardware, or a combination of hardware and software that is configured to receive and/or transmit data from/to a network and/or any other device or module in communication with the processing circuitry 110. By way of example, the communication interface 118 may be configured to enable the apparatus 102 to communicate with another computing device via a wireless network, such as a wireless local area network (WLAN), cellular network, and/or the like. Additionally or alternatively, the communication interface 118 may be configured to enable the apparatus 102 to communicate with another computing device via a wireline network. In some example embodiments, the communication interface 118 may be configured to enable communication between the apparatus 102 and one or more further computing devices via the Internet. Accordingly, the communication interface 118 may, for example, include an antenna (or multiple antennas) and supporting hardware and/or software for enabling communications with a wireless communication network (e.g., a wireless local area network, cellular network, and/or the like) and/or a communication modem or other hardware/software for supporting communication via cable, digital subscriber line (DSL), universal serial bus (USB), Ethernet or other methods.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Example Data Flow

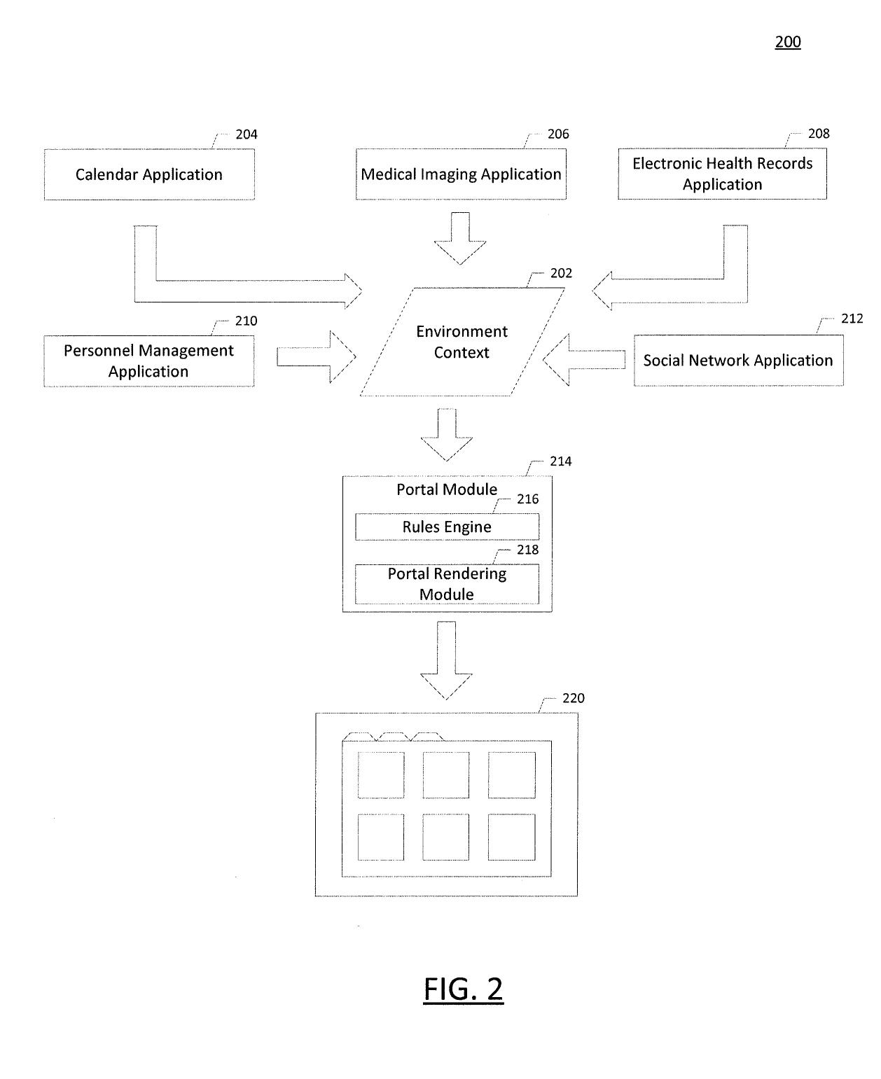

FIG. 2 is a block diagram of an example data flow 200 for implementing a context-aware clinical portal in accordance with example embodiments of the present invention. The data flow 200 illustrates how information may flow from one or more applications 204-212 to create an environment context 202. The environment context 202 may include information that is processed by a portal module 214 to assist with generation of a context-aware clinical portal 220. In this manner, the context-aware clinical portal 220 may be populated with information that is relevant to the environment context 202, thus improving the ability of a user to access relevant information in a straightforward, efficient manner.

The data flow 200 depicts a plurality of applications 204-212 that provide information that, collectively, constitutes an environment context 202. For example, the plurality of applications 204-212 may include, but should not necessarily be limited to, a calendar application 204, a medical imaging application 206, an electronic health records application 208, a personnel management application 210, and/or a social network application 212. It should be appreciated that these applications are depicted only as examples, and that an environment context could also be include information from other types of applications such as, but not limited to, a medical information system (e.g., a hospital information system, a radiology information system, a cardiovascular information system, or the like), a teaching file application, or a medical news site. It should be readily appreciated that these various information sources may be implemented as standalone applications or web based applications/websites. In some embodiments, information provided by each of the plurality of applications 204-212 may be provided by an application programming interface (API). In this manner, any application/entity that implements the API for providing context information may be able to interface with the portal management process as described herein. Additionally or alternatively, embodiments may determine the environment context through a monitoring application or applications, by monitoring message traffic to and from a workstation (e.g., Health Level 7 (HL7) messages) through the use of operating system hooks, or through any other method for tracking the execution of the plurality of applications 204-212 or receiving information from the plurality of applications 204-212. In some embodiments, applications may save data locally that can be read to determine the environment context, such as storing context information in a markup language document (e.g., an extensible markup language (XML) file). As yet another example, in some embodiments the environment context may be determined by applications storing context information to an intermediary storage medium which may be read by the portal module 214. Such an intermediary storage medium may include a database, a shared bus, or cloud data storage.

The environment context 202 may be passed to a portal module 214 to generate the context-aware clinical portal 220. The portal module 214 may process the information included in the environment context 202 to select one or more portlets for inclusion in the context-aware clinical portal 220 and to configure the portlets. The portal module 214 may include a rules engine 216 and a portal rendering module 218. The rules engine 216 may process the environment context 202 to identify whether particular data values, flags, variables, or the like are present within the environment context. For example, the rules engine 216 may include a series of criteria for selection of particular portlets for inclusion in the context-aware clinical portal 220. If the criteria for a particular portlet are met by the environment context, then the rules engine 216 may select the particular portlet for the context-aware clinical portal 220. In some embodiments, the rules used by the rules engine 216 may be defined by a user to configure the context-aware clinical portal 220, such as the user viewing the portal, an administrative user, a supervisory user, or the like. In some embodiments, the rules used by the rules engine may include instructions that specify the criteria for a particular portlet (e.g., a set of flags and Boolean operators that must be met to display the portlet), a reference to the particular portlet (e.g., instructions for executing the portlet and/or including the portlet in the context-aware clinical portal 220), and/or various other metadata about the portlet (e.g., a priority order for displaying the portlet, a set of display parameters for the portlet, a title of the portlet, and/or a subject matter of the portlet) or a maximum portlet inactivity time (e.g., how long of inactivity will cause the portlet to change its “state”). Example portlet states may include a “locked” state, where a portlet may be disabled or rendered inaccessible if idle for a period of time, or a minimized state whereby the portlet will revert to a smaller representation (e.g., a single interface control) in order to reduce clutter in the portal. Other example portlet metadata may include key words or search words associated with a portlet. These key words or search words may be used to pull-up/navigate to portlets providing/containing particular concepts by performing search operations, such that a user can perform a search using the portal and the results of the search may be portlets that have key words or search words that match the search criteria.

In some embodiments, portlets selected by the rules engine 216 may also assist with the selection of other portlets or configuration of other portlets. For example, the contents of a particular portlet may be added to the environment context 202 and the updated environment context may be utilized to select or configure other portlets for inclusion in the context-aware clinical portal 220. In some embodiments, as a user interacts with a portlet, the portlet may inform the environment context 202 of the user's interactions, thus resulting in the selection or configuration of additional portlets based on the user's interactions with the first portlet.

Once one or more portlets have been selected by the rules engine 216, a portal rendering module 218 may be employed to generate the context-aware clinical portal 220. In some embodiments, the context-aware clinical portal 220 is provided in the form of a web page viewable in a web browser, and portlets may be rendered by including code in a hosted web page or via various other methods of providing web content (e.g., hypertext markup language (HTML), JavaScript®, Adobe Flash®, HTML 5, or the like).

Generation of the context-aware clinical portal may further include selection of content for each of the selected portlets. Selection of content for the portlets may also be performed based on the environment context. Each portlet may include a set of rules or criteria for selecting content for display, along with instructions for how format and/or display the content. For example, a portlet may be selected in response to the user being scheduled for rounds on a particular floor of a hospital. The portal may relate to electronic health records, and the content of the portal may be populated with the electronic records of each patient on the particular floor of the hospital. As another example, if the user is assigned a particular imaging study for evaluation using a medical imaging application, a portlet that allows interfacing with the medical imaging application may be selected and populated with a link to the particular study. As a further example, a portlet related to a medical journal to which the user is subscribed may be selected in response to a new issue being published, and populated with links to a set of articles for the most new issue. As yet another example, a reference resource portlet may be selected based on the user selecting electronic health records for a patient with a particular condition or symptom, and the reference portlet may be populated with a link to detailed information on the particular condition or symptom in the particular reference resource (e.g., medical journal, encyclopedia, teaching file, or the like). It should be readily appreciated that various methods of selecting content would be appropriate for different portlets depending upon the type of portlet and the particular environment context.

Once the context-aware clinical portal 220 is generated, it may be provided to a user. It should be appreciated that the context-aware clinical portal 220 may be dynamically updated, adjusted, or modified based on changes to the environment context 202. For example, as the user performs various tasks throughout the day, the context-aware clinical portal 220 may dynamically update to add relevant portlets and remove irrelevant portlets. In some embodiments, portlets may be further organized using tabs, groupings, orderings, or other methods of displaying information to the user in an organized fashion. In some embodiments, changes to the environment context 202 may trigger changes in the context-aware clinical portal 220. For example, when a user opens a new application, an event may trigger causing a change to the environment context, and the portal module 214 may detect the event and regenerate portions of the context-aware clinical portal 220, such as by regenerating the entire page, re-running a portlet selection process, and/or polling individual portlets to determine if their content should be refreshed, to determine whether the portlet is still relevant, or the like. Although example embodiments herein are generally described with respect to the display the context-aware clinical portal as a web portal, it should be appreciated that the context-aware clinical portal may alternatively be rendered or realized in a non-web-based application on any sort of software enabled platform.

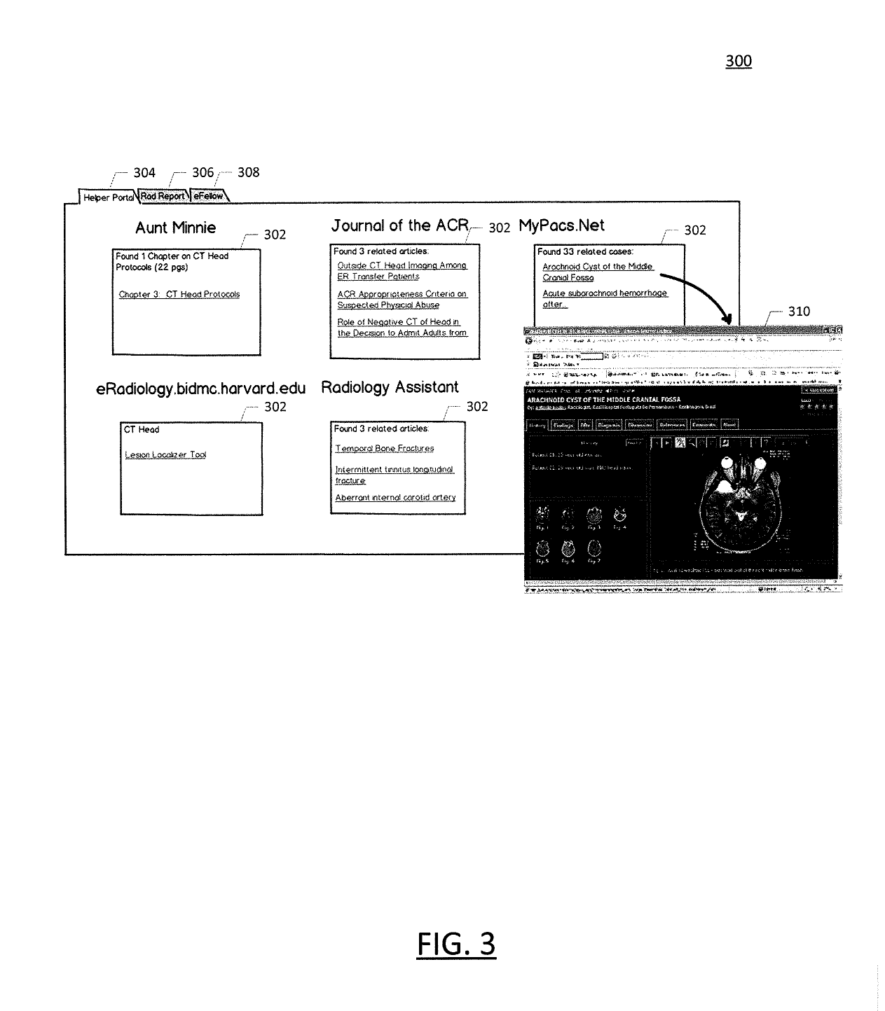

FIG. 3 illustrates an example interface 300 for providing a context-aware clinical portal. The interface 300 illustrates a context-aware clinical portal with several individual portlets determined based on an environment context. In the present example, the example interface 300 includes a plurality of reference resource portlets 302 for the various radiological information resources. The link content displayed within each of these reference resource portlets 302 relates to an imaging study being viewed by the user. This imaging study relates to a computed tomography (CT) scan of a patient's head, so the environment context includes information indicating the presence of an open imaging study, and that the imaging study is of the patient's head. The environment context may also contain information derived based on the identity of the user (e.g., based on the user's login or account credentials), such as the user's medical specialty, the user's level of experience, the user's job title, or the like. In the present example, the reference resource portlets 302 each contain links to articles or reference materials that may be useful to the user for interpretation of a medical imaging study of the patient's head.

Upon selecting the content of a particular portlet, the content may be launched via the context-aware clinical portal. For example, a new window 310 may be opened to the content selected by the user from the portlet. Although in the instant example the new window 310 is depicted as opening to a web page in a web browser application, it should be appreciated that different portlets could be associated with different applications. For example, a portlet or portlet content associated with an electronic health record application may launch the electronic health record application and open a particular record in response to selection within the portal.

Portlets may be organized through various methods, processes, and interface controls, such as, in the present example a set of tabs 304-308. In the present example, the portal is configured with a helper portal tab 304, a radiology report tab 306, and an eFellow tab 308. For example, the helper portal tab 304 may include portlets configured to provide references to the user's current clinical task (e.g., diagnosing a patient using a patient medical record or viewing a medical imaging study), and the radiology report tab 306 may include portlets configured to assist with viewing or accessing the user's radiology reports (e.g., portlets that list prior radiology results, access to prior radiology results through a Healthcare Information Exchange (HIE) repository, or other external sources for prior reports for the particular relevant patient). Alternatively, a radiology report tab may contain an interface providing a full interface to a radiology application. The eFellow tab 308 may include a portlet for a Clinical Integration Cockpit Application that queries/organizes data relevant data from electronic health records.

Portlets may be loaded in a portal view. These portlets may access and/or display any information that a user can get to/view in their environment. As specific, non-limiting examples, content provided by a portlet can come from the various resources. For example, portlets may display content from web resources, such as pages, applications, API's that include clinical web resources, social media network sites, web-enabled teaching file system, data feeds, and the like. Portlets may also display content from applications on the same “network” with publicly accessible interfaces/APIs. For example, portlets may display content from electronic health record applications, teaching file systems, a PACS, and the like. Portlets may also display content from applications installed locally on a client machine that have integration touch points (e.g. an eReader viewing application).

Different portlets may obtain content information in different ways, and portlets may display content differently depending upon the source of the content information. In the case of web pages, portlets may obtain data as a HyperText Transfer Protocol request response. For web or application based API's, content may be provided as data returned as part of an executed method. After a portlet retrieves data from a data source entity, the portlet may display the data in a variety of manners. For example, the portlet may obtain information from the source entity and control/format the data displayed. This formatting may, for example, be by directly showing the source entity data (in its entirety or a sub-section thereof) or by showing derived data based on/calculated from the source entity data. Source entities may provide data in a variety of formats, including but not limited to text, images, audio, video, and the like. Additionally or alternatively, the portlet may provide a reference link to additional and/or specific information about/in the source entity. As yet another addition or alternative method for displaying content, the portlet may act as a user interface container that embeds the source entity itself and/or its associated application/display component, within the portlet. The content that a portlet displays from a data source entity may depend on the operating context (i.e. what the user is working on, the environment state, etc.) in which the portlet is running in. This content may be controlled by rules in a similar manner as to how the rules engine is used to select portlets as described with respect to FIG. 2. A portlet may be configured to display the most optimal/helpful perspective or aspect of the data from a data source entity to a user, based on a context at a given moment in time.

As a particular example, a portlet may operate to retrieve data from an online health encyclopedia. If the environment context includes information indicating an imaging study for a patient's head, the portlet may provide encyclopedia references to skull fractures and brain anomalies. Alternatively, if environment context indicates that the imaging study is for the patient's chest, and the patient is less than 12 months old, the portlet may provide encyclopedia references to pediatric content. As another alternative, if the environment context indicates that the study is for the patient's chest and the patient is older than 40 years old, the portlet may provide encyclopedia references to heart and strokes.

The following are examples of some portlet types and implementations. It should be appreciated that the following list contains some examples of portlet types only, that the list is not exhaustive, and that various other portlets could be conceived of and implemented within the scope of the present disclosure.

An Electronic Health Records (EHR) extended clinical reference information portlet may provide access to an electronic health records application. The portlet may provide information relating to patient laboratory values, pathology values, derived clinical indications, and the like. The environment context used to derive these values may include an identifier for the patient.

A teaching file system reference study link portlet may provide access to a teaching file system. The portlet may provide links to particular reference studies. The environment context used to determine which studies to display may include the patient's symptoms and/or the patient's demographics information.

A clinical web resource reference journal portlet may provide content from a clinical web resource (e.g. medscape.com). The content provided by such a portlet may be a set of reference journal summaries and attendant links, or information on a particular procedure. The environment context used to determine which reference journal summaries may include the user's medical specialty (e.g. neurologist, orthopedic surgeon, etc.), or, in the case of a particular procedure, the procedure to be performed.

A clinical web resource diagnoses portlet may provide content from a clinical web resource to assist with diagnoses (e.g., mayoclinic.com). The content provided may include search results with info on potential causes. The environment context used to derive this content may include particular treatments being suggested for a patient.

A medical reference eBook portlet may provide access to information from an eBook through a link to an eBook viewing application (e.g. to view the eBook “Atlas of Normal Roentgen Variants That May Simulate Disease”). The portlet may provide a link to a specific page within the eBook. The environment context used to determine the eBook and page may relate to any one or more conditions associated with a patient whose records are being viewed by the user.

A health professional's social media discussions/findings portlet may provide information from a health professional social network (e.g. health equivalent to Yammer or configured pages in Yammer). This portlet may provide links to particular discussion details or threads hosted on the network, based on a particular patient identifier contained within the environment context. Additionally or alternatively, the same or a similar portlet could provide links or display of messages received via social media service (e.g., Twitter® messages from a particular user or “followed” by with a particular user account)

A clinical reference images portlet may provide links to images hosted by a PACS. A patient identifier may be specified within the environment context and the portlet may provide links to reference images associated with the patient. Selection of a link or image provided by the portlet may launch an image viewing application and allow the user to view the associated reference image.

An online encyclopedia portlet may provide access to a collaborative Internet encyclopedia (e.g. Wikipedia), and display content for a particular page. The context may be any health term present within the environment context (e.g., by scraping viewed content for text data).

A web-based radiology decision support tool portlet may provide content from a radiology medical reference web-site (e.g., www.learningradiology.com). This content may include links to diagnosis information or images relating to a particular body region present in the environment context (e.g., a body region displayed in an imaging study or a body region described with respect to patient symptoms discussed in a patient electronic health record).

A pharmaceutical web resource portlet may provide access to an online pharmacist reference (e.g. “canadianpharmacistsletter.therapeuticresearch.com”). The content of this portlet may include links to lists of and information on the side effects of drug, based on identification of a particular drug name or identifier from the environment context.

A study quality manager portlet may provide access to a quality management data repository for providing quality assurance over particular imaging studies. The study quality manager portlet may provide links to studies that are ready for quality evaluation, in response to detecting that there are studies ready to be reviewed based on the environment context and that the user has proper permissions to conduct the quality assurance audit.

A physician communication portlet may provide information used to contact a particular physician, such as their e-mail address, telephone number, and/or schedule. The physician communication portlet may select particular physicians based on the environment context, such as by identifying a physician who met with the patient during a particular encounter detailed in a medical record being viewed by the user. The content displayed in the portlet may facilitate communication with the physician, such as by launching an e-mail client in response to selecting an e-mail address displayed in the portlet.

### Example Processes for Providing a Context-Aware Clinical Portal

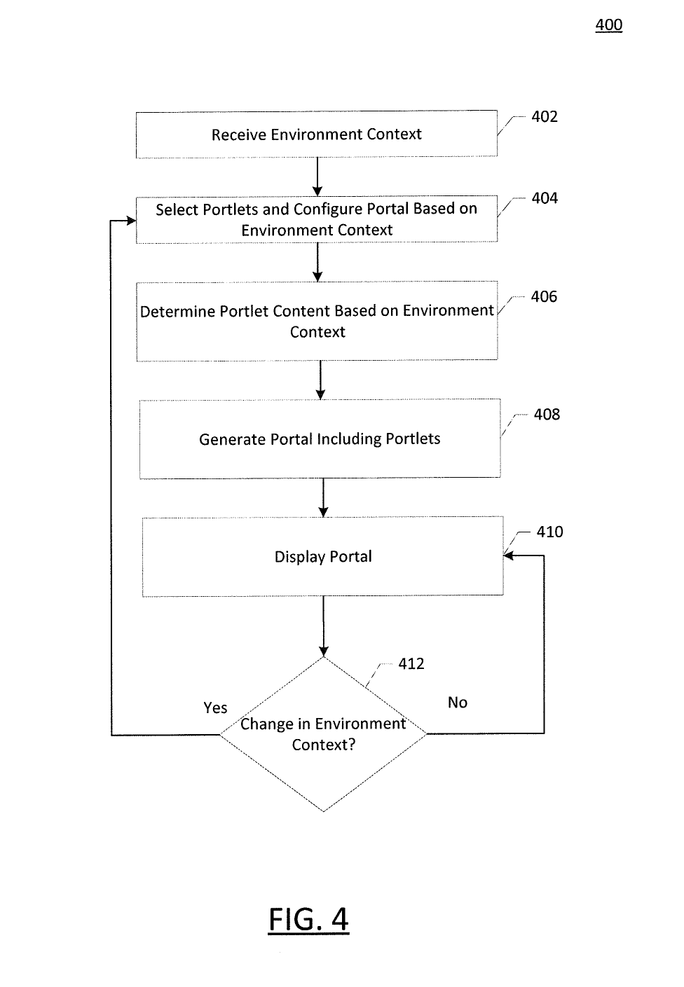

FIG. 4 is a flow diagram of an example process 400 for providing a context-aware clinical portal in accordance with embodiments of the present invention. As described above, embodiments may function to provide a context-aware clinical portal by determining an environment context from one or more applications. The environment context may be used to select one or more portlets for inclusion in the context-aware clinical portal. Each portlet may be associated with a particular type of content, which may also be determined based on the environment context. When criteria established for each portlet are met by the environment context, the portlet may be included in the portal. Embodiments of the process 400 may be performed by an apparatus, such as the apparatus 102 described with respect to FIG. 1. In some embodiments, such an apparatus executes a portal module to facilitate the operations of the process 400, such as the portal module 214 described with respect to FIG. 2.

The process 400 may begin by determining and/or receiving an environment context at action 402. As described above, the environment context may be provided by one or more applications. These applications may provide the environment context via being monitored by a portal module, through the use of an API, via a messaging system, or any other method of providing information that may be useful in configuring the context-aware clinical portal.

At action 404, the environment context is processed to select one or more portlets to configure the portal. As described above, selection of portlets may be performed through the use of a rules engine which determines whether the criteria for particular portlets are met by the environment context.

Rules for selecting particular portlets may include conditional expressions composed of Boolean logic joined conditions involving 1 attribute in the available context. These values may be evaluated at defined trigger points in a workflow. The rules may also include display action(s) to perform in the portal or portlet if the condition expression is true (or if there is no condition expression). Provided environment context information may include, but is not limited to, attributes from the application the user is using (e.g., the application name), attributes from the workflow (state) that the user is on (e.g., a web page name), attributes from the users themselves (e.g., the user's role), attributes from the particular item that a user is looking at (e.g., an identifier), and/or attributes from portlet contents (e.g., some specific portlet data displayed in other portlets).

The actual display action(s) that are available for a rule may depend on the target being configured. For example, in the case of the portal, the action(s) available may be to “display a particular portlet”. In the case of a portlet, the action(s) available may be different for and specific to each portlet, and depend on the type of data & way that data is displayed. For instance, in an EHR portlet, action(s) may include “show lab values” or “show pathology values”, while in a teaching file system portlet, action(s) may include “show latest cases” or “show search results for a particular context”. As a further example, actions for a clinical web reference resource portlet may include “show results page for search term for a particular context” or “show journal page”, actions for a health professionals social media discussion/findings portlet may include “show latest posts” or “show posts related to a particular context”, and actions for a clinical reference viewer portlet may include “show related images for a particular context”.

At action 406, the content for each selected portlet may be determined by the particular portlet. For example, portlets may look for certain key words, conditions, or other criteria within the environment context in the same or a similar manner to how the rules engine evaluates the environment context. Based on the presence of these key words, conditions, or other criteria, the portlet may select particular content for display. As described above, portlets may provide links or interface controls that otherwise provide access to various types of content, including but not limited to web pages, reference resources, patient health records, imaging studies, and the like.

When rule configurations are initially setup, a user may first set-up the portal configuration, and then setup the configuration for any portlets that may be displayed. These rule configurations may be modified by the user, or a default configuration may be used. An example of a rule configuration a system may have for configuring a portal is as follows:

TABLE 1

| PORTAL RULE #1: | |
|---|---|
| Condition Expression: (current_page != “study”) AND | |
| (user_type == “radiologist”) | |
| Action(s): show clinical web reference resource portlet | |
| CLINICAL WEB REFERENCE PORTLET RULE #1: | |
| Condition Expression: (user = “dr_abc”) | |
| Action(s): show results page for search term “radiology” | |
| CLINICAL WEB REFERENCE PORTLET RULE #2: | |
| Condition Expression: (user != “dr_abc”) and | |
| (journal title contains “radiology”) | |
| Action(s): | show radiology journal articles |
| | show teaching file system portlet |

| TEACHING FILE SYSTEM PORTLET RULE #1: | |
|---|---|
| Condition Expression: None | |
| Action(s): show latest cases | |
| PORTAL RULE #2 | |
| Condition Expression: (application == “HMI”) AND | |
| (current_page != “study”) AND | |
| (user_type == “resident”) | |
| Action(s): | |
| TEACHING FILE SYSTEM PORTLET RULE #1: | |
| Condition Expression: None | |
| Action(s): | show latest cases |
| | show search results for “resident training” |
| PORTAL RULE #3: | |
| Condition Expression: (application == “HMI”) AND | |
| (current_page == “study”) | |
| Action(s): | |
| EHR PORTLET RULE #1: | |
| Condition Expression: (modality == “CT”) AND | |
| (body_region=“heart”) | |
| Action(s): | show lab values |

| EHR PORTLET RULE #2: | |
|---|---|
| Condition Expression: None | |
| Action(s): | show pathology values |

```
PORTAL RULE #4:
    Condition Expression: (application == “MC”) AND
    (current page == “study”)
    Action(s):
    CLINICAL WEB REFERENCE PORTLET RULE #1:
        Condition Expression: (journal title contains “heart”) OR
        (journal title contains
        “cardio”)
        Action(s): show cardiology journal articles
```

At action 406, the content for each selected portlet may be determined by the particular portlet. For example, portlets may look for certain key words, conditions, or other criteria within the environment context in the same or a similar manner to how the rules engine evaluates the environment context. Based on the presence of these key words, conditions, or other criteria, the portlet may select particular content for display. As described above, portlets may provide links or interface controls that otherwise provide access to various types of content, including but not limited to web pages, reference resources, patient health records, imaging studies, and the like.

At action 408, the portal is generated using the selected portlets. As described above, generating the portal may include generating markup language code for displaying the portal, providing the portal in an executable format, generating JavaScript® to create the portal, or by any other method for providing a content interface to the user. Generation of the portal may include embedding the selected portlets within the page, and allowing the portlets to execute on the user's device, or the portlet content may be determined during the portal generation process such that portlet content is also generated when the portal is generated.

At action 410, the portal is provided to the user for display. For example, the portal may be provided for display in a user web browser, on a user PACS workstation, or in any other format that allows the user to view and interact with the portal. At action 412, a determination is made as to whether the environment context has changed. In some embodiments, the environment context may be monitored during and following generation of the portal. A change in the environment context may cause an event to be registered by a portal module such that the portal is dynamically updated as the environment context changes. For example, a patient status may change, or a new imaging study may be provided to the user to review, and the portal will be updated to reflect the change in circumstances. If the environment context has changed, the process may return to action 404 to update the portal based on the new environment context. Otherwise, the process may return to action 410 to continue display of the portal.

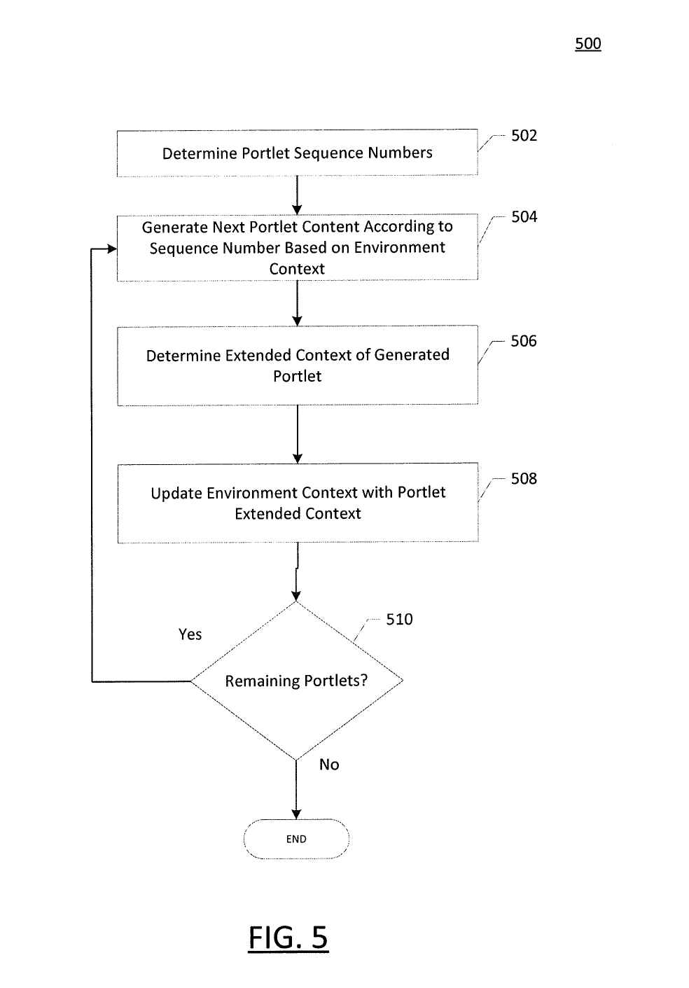

FIG. 5 is a flow diagram of an example process 500 for determining an environment context using a portlet extended context in accordance with embodiments of the present invention. As described above, portlets may utilize the environment context to determine which content to display. In some embodiments, portlets themselves may have additional contexts or facilitate updating of the environment context. For example, when a portlet is selected or activated, it may extend the environment context by providing additional attributes or attribute types, or by modifying attributes already existing within the context. The process 500 depicts one possible implementation for such a system. Embodiments of the process 400 may be performed by an apparatus, such as the apparatus 102 described with respect to FIG. 1. In some embodiments, such an apparatus executes a portal module to facilitate the operations of the process 400, such as the portal module 214 described with respect to FIG. 2.

At action 502, a sequence number for a set of portlets is determined. This sequence may be derived from portlet metadata that establishes a priority order for display and/or processing of portlets, such that portlets with a higher priority are displayed and/or processed first. It should be appreciated that although portlets are described as updating in a sequence in the instant example, portlets could also be processed and updated in parallel.

At action 504, content for a next portlet in the sequence is determined. For example, as described above, the portlet may identify particular reference terms, key words, or the like within the environment context to provide the user with content that is relevant to the environment context in which the user is operating.

At action 506, any extended context for the particular portlet is determined. It should be appreciated that the context used to select portlets, and the context(s) used by the displayed portlets to determine what/how to show data, are not necessarily all the same. For example, the portal selection logic described above may make use of what is known as the “base context”, which describes the system/environment state/attributes that are available at the time the portal is initially generated. As portlets are loaded, their own context (returned or parsed/scrubbed from the data that is retrieved/available through each data source entity that a portlet is connected to) can be added to the “base context” to provide additional attributes or information not previously found in the base context. As a result, portlets may access this “extended context” for their rule configuration. This “extended context” may be seen as being fluid/dynamic, as it may continually change/grow as more information becomes available within a particular portal view. For example, when a user initially opens a medical image study, the user may be presented with portlets associated with viewing the study and any electronic health records for the patient associated with the medical image study. When a portlet associated with the electronic health records loads, the EHR portlet may automatically obtain patient record data and note that the patient had a biopsy performed with the potential for vasculitis. In response, the EHR portlet may add “Vasculitis” to the environment context to notify other portlets that the patient may have the condition of vasculitis. Other portlets may utilize this information to provide relevant references to this condition.

In some cases, portlets in a portal view may not require the need for the “extended context”, as the “base context” is enough in their rule configuration. In these instances the “base context” may be available to all portlets when a portal view is first loaded, and thus all portlets (and by extension their rule configurations) can load simultaneously.

In cases where use of the “extended context” is used in a portlet (i.e. its rule configurations), portlets may be loaded according to the sequence/order specified at action 502. This sequence/order may be configured as part of the rules configuration for a portal view. Specifically, when configuring action(s) to “display a particular portlet”, a sequence/order value may also be supplied. As such, all portlets with the same sequence/order value may load simultaneously. Portlets may only load after all the portlets preceding them in the sequence/order chain are finished loading.

At action 508, the environment context is updated with the context of the particular portlet. At action 510, the process determines whether there is a next portlet in the sequence. If so, the process returns to action 504 to process the next portlet. Otherwise, the process 500 ends.

It will be understood that each element of the flowcharts, and combinations of elements in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 114 of an apparatus employing an embodiment of the present invention and executed by a processor 112 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving an environment context, the environment context comprising information relating to at least one of a user task, a user action, or an open application;
determining, using a processor and based on the environment context, at least one portlet for providing clinical information related to the environment context, wherein the at least one portlet provides an interface control for at least one of viewing or accessing the clinical information;
generating a context-aware clinical portal comprising the at least one portlet; and
providing the context-aware clinical portal.

2. The method of claim 1, wherein the environment context comprises information provided by at least one of a picture archiving and communication system, a calendar application, an electronic health records system, or a medical reference application, a medical information system, a teaching file application, a social media application, or a medical news site.

3. The method of claim 1, further comprising:
receiving at least one update to the environment context; and
updating the context-aware clinical portal based on the updated environment context.

4. The method of claim 3, wherein the update to the environment context is received from the at least one portlet.

5. The method of claim 4, wherein the update received from the at least one portlet extends the environment context by adding at least one additional attribute to the environment context not present prior to the update.

6. The method of claim 1, wherein the clinical information comprises at least one of a link to a medical reference resource, a link to a patient electronic health record, a teaching file case, a medical report, or a link to a medical imaging study.

7. The method of claim 1, further comprising:
associating a sequence priority to each of the at least one portlets; and
determining the clinical information for each of the at least one portlets according to the sequence priority.

8. The method of claim 1, wherein the environment context is provided at least in part by an application programming interface.

9. The method of claim 1, wherein the environment context comprises at least one of a patient identifier, a patient symptom, an open examination attribute, an open procedure attribute, patient demographic information, or a user clinical specialty.

10. The method of claim 1, wherein the context-aware clinical portal is provided via a web page interface.

11. An apparatus comprising processing circuitry configured to cause the apparatus to:
receive an environment context, the environment context comprising information relating to at least one of a user task, a user action, or an open application;
determine, based on the environment context, at least one portlet for providing clinical information related to the environment context, wherein the at least one portlet provides an interface control for at least one of viewing or accessing the clinical information;
generate a context-aware clinical portal comprising the at least one portlet; and
provide the context-aware clinical portal.

12. The apparatus of claim 11, wherein the environment context comprises information provided by at least one of a picture archiving and communication system, a calendar application, an electronic health records system, or a medical reference application.

13. The apparatus of claim 11, further configured to:
receive at least one update to the environment context; and
update the context-aware clinical portal based on the updated environment context.

14. The apparatus of claim 13, wherein the update to the environment context is received from the at least one portlet.

15. The apparatus of claim 14, wherein the update received from the at least one portlet extends the environment context by adding at least one additional attribute to the environment context not present prior to the update.

16. The apparatus of claim 11, wherein the clinical information comprises at least one of a link to a medical reference resource, a link to a patient electronic health record, or a link to a medical imaging study.

17. The apparatus of claim 11, further configured to:
associate a sequence priority to each of the at least one portlets; and
determine the clinical information for each of the at least one portlets according to the sequence priority.

18. The apparatus of claim 11, wherein the environment context is provided at least in part by an application programming interface.

19. The apparatus of claim 11, wherein the environment context comprises at least one of a patient identifier, a patient symptom, an open examination attribute, an open procedure attribute, patient demographic information, or a user clinical specialty.

20. A computer program product comprising at least one computer-readable storage medium bearing computer program instructions embodied therein for use with a computer, the computer program instructions comprising program instructions configured to:
receive an environment context, the environment context comprising information relating to at least one of a user task, a user action, or an open application;
determine, based on the environment context, at least one portlet for providing clinical information related to the environment context, wherein the at least one portlet provides an interface control for at least one of viewing or accessing the clinical information;
generate a context-aware clinical portal comprising the at least one portlet; and
provide the context-aware clinical portal.
